(19) United States
(12) Patent Application Publication
(10) Pub. No.: US 2026/0220958 A1
(43) Pub. Date: Jul. 30, 2026

(54) COMPUTER-IMPLEMENTED METHOD FOR RECOGNIZING COMPUTER-READABLE TEXT AND STORAGE MEDIA

(71) Applicant: PETRÓLEO BRASILEIRO S.A. - PETROBRAS, RIO DE JANEIRO (BR)

(72) Inventors: Claudio Daniel Tenorio De BARROS, Rio de Janeiro (BR); Bruno De Souza E Silva BORSATO, Rio de Janeiro (BR)

(73) Assignee: PETRÓLEO BRASILEIRO S.A. - PETROBRAS, RIO DE JANEIRO (BR)

(21) Appl. No.: 19/454,793

(22) Filed: Jan. 21, 2026

(30) Foreign Application Priority Data
Jan. 28, 2025 (BR) 1020250017202

(51) Int. Cl. G06V 30/262; G06F 40/106; G06F 40/143; G06F 40/177; G06F 40/232; G06F 40/253; G06F 40/30; G06F 40/40; G06V 10/82; G06V 30/19

(52) U.S. Cl. CPC G06V 30/274; G06F 40/106; G06F 40/143; G06F 40/177; G06F 40/232; G06F 40/253; G06F 40/30; G06F 40/40; G06V 10/82; G06V 30/191

(57) ABSTRACT

Computer-implemented method for text recognition, comprising the steps of: receiving a scanned file; including at least one metadata for the scanned file; creating a unique identifier for a workflow associated with the scanned file; refining and enhancing the text extracted by OCR, using the Large-Scale Language Model (LLM) module; reconstructing the text; temporary storage of the file; user decides whether to interact with an interactive chat tool; implementing an interactive chat interface; processing user queries and generating contextualized responses using the Large-Scale Language Model (LLM); and outputting a response generated by the Large-Scale Language Model (LLM).

### RELATED APPLICATION DATA

This application is based on and claims priority to Brazilian Application No. BR 10 2025 001720 2, filed on Jan. 28, 2025, the entire contents of which are incorporated herein by reference.

### FIELD OF THE INVENTION

The present invention is situated in the technical field of intelligent systems, more specifically, intelligent systems for text recognition. Thus, the present invention defines a computer-implemented method for recognizing text and computer-readable storage media.

### BACKGROUND OF THE INVENTION

Reading and interpreting documents that are difficult to read, such as those that are scanned, handwritten, or have watermarks, represents a significant challenge for traditional Optical Character Recognition (OCR) systems. These systems frequently fail to provide accurate and reliable results, limiting their usefulness in several applications.

Some problems related to optical character recognition of documents that are difficult to read include: low accuracy in converting text in lower-quality documents; high error rate in damaged, overlapping, or partially visible characters in a document; difficulty in interpreting context and automatically correcting errors, leading to misinterpretations of ambiguous or malformed words; frequent need for manual intervention to correct transcription errors, prone to human error; and inefficiency in processing documents on a large scale.

Traditional OCR systems use pattern-based algorithms to convert text images into digital format by comparing character shapes in the image with predefined patterns in their database. However, this approach has limitations, which are discussed in detail below.

Low accuracy in complex documents: Traditional OCRs often fail to process low-quality documents because they rely on clear and well-defined patterns; visual noise, such as smudges, folds, or shadows, interferes with the correct identification of characters.

Difficulty with typographical variations: accuracy decreases significantly with non-standard fonts or unusual typographical styles, and textual marks, special characters, or symbols are often misinterpreted due to a lack of exact correspondence with known patterns.

Ineffectiveness in manuscripts: the variability of human handwriting surpasses the ability of recognition based on fixed patterns, resulting in frequent errors. Historical documents or handwritten notes are rarely processed successfully due to the complexity and variability of handwritten forms.

Interference from graphic elements: watermarks, stamps, or decorative elements confuse algorithms, as they are interpreted as part of the text to be recognized.

Lack of contextualization: traditional OCRs operate at the character or word level, without understanding the semantic context. Interpretation errors in ambiguous or misspelled words are common due to a lack of contextual understanding, resulting in meaningless transcriptions.

Extensive post-processing required: low accuracy requires extensive manual review and correction, consuming significant time and resources. The manual correction process is prone to human error, potentially introducing new inaccuracies.

Limitations in content analysis: traditional OCR systems focus only on transcription, without the ability to analyze or extract insights from the content. The interpretation and synthesis of complex information remain exclusively human tasks. Transcription errors can result in the loss or distortion of critical information in important documents, limiting their use in decision-making processes. In addition, extensive manual post-processing and the need for human verification create bottlenecks in document-based workflows. The inability to process complex documents restricts access to information for users dependent on digitized versions, and historical or difficult-to-read documents remain inaccessible for automated digital analysis.

In this context, such limitations indicate the need for a more advanced solution, capable of overcoming the challenges presented by traditional OCR systems and offering a more robust and intelligent approach to processing complex documents.

### STATE OF THE ART

The document MENG, F.; WANG, C. -A. Artificial Intelligence and Machine Learning Approaches to Text Recognition: A Research Overview. J. Math. Techniques Comput. Math. 3(3), 01-05 (2024) proposes a set of innovative methodologies designed to significantly improve the accuracy of text recognition models. These methodologies encompass strategies for improving data quality and diversity, optimizing processes for large-scale training and inference, providing comprehensive support for a multitude of languages and typographies, addressing variations in text layout and settings, achieving accurate handwritten text recognition, and improving the interpretability and explainability of models. The document is quite generic and comprehensive.

Furthermore, the U.S. Pat. No. 11,481,691 shows a non-transient readable medium that stores instructions to be executed by a processor to have the processor receive a first trained machine learning model that generates a transcript based on a document. The instructions then cause the processor to execute the first trained machine learning model and a second trained machine learning model to generate a refined transcript based on the transcript. Furthermore, the processor runs a quality assurance program to generate a refined transcription score based on the refined transcription and at least one of the document or transcript.

Additionally, the document BR 102022010870-6 teaches a method for extracting and structuring information, in which the method receives an unstructured document as input, extracts its information, reorganizes it, and makes this information available in files that can be consumed by other systems. This document defines a page separator model for the document, a block detection and segmentation model, a table extractor, an image extractor, an image classification model, a text extractor, a computer vision model for improving the image quality of texts, an optical character recognition model, a spelling correction model, models for semantic enrichment of the text, an organizer of output files, and a metadata aggregator for information enrichment. This document teaches a process that allows the digitization and recognition of handwritten texts and answer cards in Portuguese using artificial intelligence. The process is geared towards exam correction and can also be used in medical prescriptions. The document in question uses optical character recognition, in addition to an OCR algorithm.

### BRIEF DESCRIPTION OF THE INVENTION

An objective of the present invention is to address the challenges of the state of the art through a sequential approach to improving OCR results and contextual interaction with transcribed documents.

In general, the present invention offers the following advantages:
Effective reading and interpretation of documents previously considered difficult to read, with significantly increased accuracy;
Substantial improvement in automatic error correction, based on deep contextual understanding;
Ability to extract implicit information and make inferences based on document content and the general knowledge of LLM;
Drastic reduction in the need for manual correction, increasing the efficiency of document processing;
Expansion of complex document processing capabilities, allowing sophisticated analyses and extraction of insights that go beyond mere transcription.

The proposed invention represents a significant technological advancement in the field of document processing, offering a comprehensive solution that not only overcomes the limitations of traditional OCR systems but also introduces advanced document interpretation and analysis capabilities. This results in tangible benefits in terms of efficiency, accuracy, and applicability in several professional and academic contexts, fundamentally transforming the way information is extracted and used from complex documents.

Thus, the present invention describes a computer-implemented method for text recognition, comprising the steps of:
receiving a scanned file, which includes receiving a scanned file on a processing server;
including at least one metadata for the scanned file, which includes file size, file format, and file receipt time;
creating a unique identifier for a workflow associated with the scanned file, in a workflow management module;
extracting text and structuring the scanned file by Optical Character Recognition (OCR);
refining and enhancing the text extracted by OCR, by the Large-Scale Language Model (LLM) module, which includes semantic analysis of the text for contextual understanding and correction of gaps or inaccuracies in the text;
reconstructing the text;
temporary storage the file in primary memory, by the temporary storage module;
user decides whether to interact with an interactive chat tool;
implementing an interactive chat interface, through the chat interface module, if the user decides to interact with the interactive chat tool;
processing user queries and generating contextualized responses using Large-Scale Language Model (LLM); and
outputting a response generated by the Large-Scale Language Model (LLM).

The step of receiving a scanned file also includes verifying if the format of the scanned file corresponds to a supported format, where the supported format includes any of the following formats: PDF, JPEG, PNG, TIFF, DOC, DOCX, XLS or XLSX or any other format that includes a scanned file.

The step of extracting text and structuring the scanned file by Optical Character Recognition (OCR) includes the use of optical character recognition algorithms, including convolutional neural networks (CNNs), recurrent neural networks (RNNs) and Transformers; Extracting text and structuring the digitized file also includes processing a plurality of languages and font styles through the use of pre-trained models on a plurality of texts in different languages, styles, and formats.

The OCR-extracted text refinement and enhancement step also includes identifying inconsistencies and ambiguities in the extracted text based on explicit guidelines given to the model; spelling and grammar correction based on the document context; reconstruction of lists and tables; adjusting connectors and transitions between paragraphs to improve text flow; harmonizing styles and tones throughout the document; and adjusting the level of formality and terminology based on the document type.

The text reconstruction step (5) includes:
transforming refined text into Markdown format, preserving the structural hierarchy (titles, subtitles, paragraphs) of the document;
converting textual elements into Markdown syntax, including: formatting ordered and unordered lists, bold and italic emphasis; creating internal and external links, when applicable; formatting quotations and code blocks, if present;
converting identified tables to Markdown table format;
aligning columns and format table headers;
applying consistent styles to improve readability;
inserting line breaks and appropriate spacing.

The step of temporarily storing the file in primary memory includes associating the stored file with a user session.

Furthermore, the method also includes:
displaying the file in the user interface, which includes converting Markdown to HTML format for display in the browser and applying CSS styles to improve readability and appearance.

The step of processing user queries and generating contextualized responses using Large-Scale Language Model (LLM) includes:
incorporating relevant conversation history;
including pertinent parts of the processed document;
structuring the question of the user in a format optimized for LLM processing;
including specific instructions based on the query type;
generating a response considering the complete context of the interaction with the document.

Furthermore, according to another preferred embodiment of the present invention, a computer-readable storage medium is defined comprising, stored therein, a set of computer-readable instructions, which, when executed by a computer, executes the computer-implemented method for text recognition.

### BRIEF DESCRIPTION OF THE FIGURES

In order to complement the present description and to obtain a better understanding of the features of the present invention, and according to a preferred embodiment thereof, attached is FIG. 1, which exemplifies, though not limitingly, its preferred embodiment.

FIG. 1 illustrates the flowchart of the computer-implemented method for text recognition.

FIG. 2 shows the first document, which is an English document of the Declaration of Independence of the United States of America.

FIG. 3 shows the second document, which is a document in Portuguese referring to a Property Registry—Registration No. 311.

FIG. 4 shows a comparison of the different distance metrics implemented to assess the similarity between the generated transcripts and the reference text.

FIG. 5 shows a complementary analysis, focusing on similarity metrics that capture different aspects of the relationship between the transcripts and the reference text of the English document.

FIG. 6 shows a comprehensive comparison of the different distance metrics implemented to assess the similarity between the generated transcripts and the reference text of the Portuguese document.

FIG. 7 shows a complementary analysis, focusing on similarity metrics that capture different aspects of the relationship between the transcripts and the reference text of the document in Portuguese.

### DETAILED DESCRIPTION OF THE INVENTION

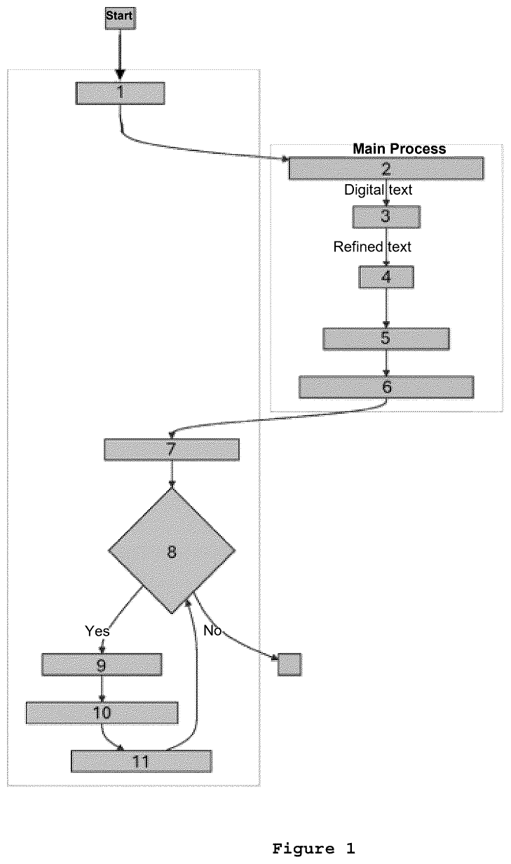

Firstly, as illustrated in FIG. 1, it begins with the presentation of a graphical user interface, which serves as an entry point for the process of processing and interacting with digitized files. In this sense, an interface based on user-centered design principles is displayed, such as a clear layout with visual hierarchy, explicit labels for functions, and logical grouping of related elements. In addition, responsive design elements are incorporated to adapt to different devices and screen sizes. In this sense, options are made available for uploading files through a clickable button and information on support for different file formats is provided to the user, as well as other guidelines, such as the maximum size of documents, and visual feedback on the progress of the file upload.

Furthermore, in the graphical interface, there is an option to select the desired quality for the transcribed document and an option to request the preference to view the transcript after processing or store it only in memory.

The computer-implemented method for text recognition, comprising the steps of:
receiving a scanned file (1), which includes receiving a scanned file on a processing server;
wherein the step of receiving a scanned file (1) also includes verifying whether the format of the scanned file corresponds to a supported format, where the supported format may include any format among: PDF, JPEG, PNG, TIFF, DOC, DOCX, XLS or XLSX or any other format that includes a scanned file;
including at least one metadata for the scanned file, where the metadata includes file size, file format and time of file receipt;
creating a unique identifier for a workflow associated with the scanned file (2), in a workflow management module;
extracting text and structuring the scanned file (3) by Optical Character Recognition (OCR), which includes the use of optical character recognition algorithms, including convolutional neural networks (CNNs), recurrent neural networks (RNNs) and Transformers;
wherein extracting text and structuring the scanned file (3) also includes processing a plurality of languages and font styles through the use of pre-trained models on a plurality of texts of different languages, styles and formats;
refining and enhancing the text extracted by OCR (4), by the Large-Scale Language Model (LLM) module, which includes semantic analysis of the text for contextual understanding and correction of gaps or inaccuracies in the text;
wherein the step of refining and improving the text extracted by OCR (4) also includes identifying inconsistencies and ambiguities in the extracted text based on the explicit guidelines given to the model; spelling and grammar correction based on the document context; reconstruction of lists and tables; adjusting connectors and transitions between paragraphs to improve text flow; harmonizing styles and tones throughout the document; and adjusting the level of formality and terminology based on the document type;
reconstructing the text (5) which includes:
   transforming refined text into Markdown format, preserving the structural hierarchy (titles, subtitles, paragraphs) of the document;
   converting textual elements into Markdown syntax, including: formatting ordered and unordered lists, bold and italic emphasis; creating internal and external links, when applicable; formatting quotations and code blocks, if present;
converting identified tables to Markdown table format;
aligning columns and formatting table headers;
applying consistent styles to improve readability;
inserting line breaks and appropriate spacing;
temporary storage of the file in primary memory (6), by the temporary storage module, which includes associating the stored file with a user session;
displaying the file in the user interface (7), which includes converting Markdown to HTML format for display in the browser and applying CSS styles to improve readability and appearance;
user decides whether to interact (8) with the interactive chat tool;
implementing an interactive chat interface (9), through the chat interface module, if the user decides whether to interact with the interactive chat tool;
processing user queries and generating contextualized responses using Large-Scale Language Model (LLM) (10), which includes:
   incorporation of relevant conversation history;
   inclusion of pertinent parts of the processed document;
   structuring the question of the user in a format optimized for LLM processing;
   inclusion of specific instructions based on the query type;
   generating a response considering the complete context of the interaction with the document;
outputting a response generated by the Large-Scale Language Model (LLM) (11).

After the step of outputting a response generated by the Large-Scale Language Model (LLM) (11), the method includes an interaction loop that manages the continuous cycle of interaction between the user and the system, including:
evaluating whether the user wants to continue or end;
updating the conversation context;
restarting the query processing module if necessary.

Furthermore, the method also includes a finalization step responsible for the orderly termination of the session and the cleanup of the resources used, including the release of memory allocated for the chat file and history, and the termination of active network connections.

In particular, the step of receiving a scanned file (1) includes transferring a scanned document from a user device to a processing server. Furthermore, with regard to verifying whether the transferred file is in one of the supported formats, any rejection of an unsupported format is carried out with appropriate feedback to the user in the initial graphical interface. In particular, the file transfer or upload is carried out by a secure upload mechanism, potentially using encryption during transmission. The upload progress is monitored and displayed to the user. The scanned file is stored in temporary storage, in an area designated for later processing, such as in the primary memory of the processing server or in some cloud storage.

The workflow management module is responsible for coordinating and supervising all document processing steps, from upload to final interaction with the user. The workflow management module defines the sequence of operations to be performed on the document; allocates computational resources for each step of the process; implements a queuing system to manage multiple documents in processing; executes tasks in parallel to optimize resource usage; performs dependency management between processing steps; real-time monitoring of the progress of each process step; records detailed logs for later analysis and troubleshooting; implements recovery mechanisms to handle failures in specific steps; notifies the user in case of critical errors that prevent processing; determines the appropriate time to advance to the next processing step; ensures that all necessary steps are completed before releasing the final result.

Specifically, the step of extracting text and structuring the scanned file (3) by Optical Character Recognition (OCR) includes the use of Azure Document Intelligence, but the method can be performed by other commercial tools, such as AWS Textract, Google Cloud Vision AI, OpenAI GPT-4 Vision, or traditional OCR solutions such as Tesseract OCR. The choice of the specific tool will depend on project requirements, cost considerations, and resource availability.

The Large-Scale Language Model (LLM) module is responsible for building a structured prompt for the language model, which includes:
a. Accurate instructions: A set of detailed guidelines that guide the model on how to process and refine the text;
b. Document context: Information about the document type, format, and origin;
c. Raw OCR text: The content extracted by the OCR process;
d. OCR metadata: Information about the confidence of the recognition and the identified structure.

The prompt is built upon:
a. Iterative optimization: Refinement based on extensive testing with various document types;
b. Instruction balancing: Balance between specific guidelines and flexibility to adapt to different contexts;
c. Parameter control: Fine-tuning of temperature, top_p, and other model parameters to optimize performance;

The prompt includes specific instructions to:
a. Maintain fidelity to the original content;
b. Correct spelling and grammatical errors;
c. Resolve ambiguities based on the context of the document;
d. Reconstruct complex textual structures when necessary.

While the current implementation uses Azure OpenAI GPT-40, the method of the present invention is flexible and can be adapted to use other large-scale language models, such as Google Gemini 1.5 Pro, Anthropic Claude 3.5, or Meta LLaMA 3.1. The choice of the specific model will depend on factors such as performance, cost, privacy requirements, availability, and operational costs.

The temporary storage module is responsible for the temporary storage of the processed document in primary memory for fast access during the user interaction session. The temporary storage module reserves memory space to store the processed document; optimizes allocation to balance performance and efficient resource use; associates the stored document with the user session; implements mechanisms to release memory when the session is terminated; maintains data integrity during read operations and possible updates; synchronizes access in case of multiple threads or processes.

The chat interface module implements an interactive chat interface to allow the user to ask questions about the processed document. The interactive chat interface includes a message display area with automatic scrolling and a text input field for interaction. In addition, chat session management includes maintaining the history of the current conversation and options to clear or save the history.

It is important to note that, although specific tools and models have been mentioned in the current implementation, the proposed method is fundamentally technology-agnostic. The flexibility of the method allows its adaptation to different technological environments, whether they are based on public cloud solutions (such as AWS, Azure, or Google Cloud), on-premises platforms, or a hybrid combination.

Additionally, the present invention relates to a computer-readable storage medium, which comprises, stored within itself, a set of computer-readable instructions, wherein when the set of computer-readable instructions is executed by one or more processors, the one or more processors implement the method of the present invention, as described above.

In particular, the computer-readable storage medium may be memory, wherein the memory may be of a non-volatile type, such as a hard disk drive (HDD) or a solid-state drive (SSD), or it may be volatile memory, such as random-access memory (RAM). Furthermore, the readable storage medium may be any other medium or means that can carry or store or record the expected program code in the form of an instruction or a data structure or a set of instructions and can be accessed by one or more computers or one or more processors but is not limited to them. The readable storage medium may alternatively be a circuit or any other device or means that can implement a storage or transport or recording function, such as a signal or a carrier.

Specifically, the computer-readable instruction set represents the algorithm or computer program code or data structure that performs the method of the present invention described above.

The processor can be a general-purpose processor, which can be a microprocessor or any conventional processor or similar.

### Comparisons of the Present Invention With Other Next-Generation Transcription Tools

Optical Character Recognition (OCR) allows the conversion of physical documents into digital formats. Recent advances in artificial intelligence and machine learning have led to the development of several OCR methods.

The present invention shows a new OCR method and compares its performance with two technologies from the state of the art: Azure Document Intelligence and GPT-4 Vision. The comparison focuses on transcription accuracy and semantic adequacy, using two historical handwritten documents as test cases: one in English and the other in Portuguese.

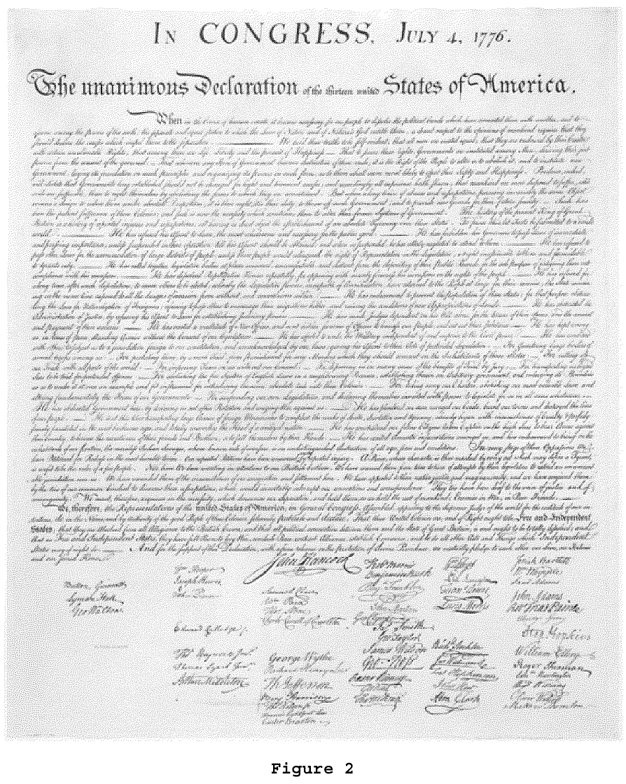

The first document is the English document referring to the Declaration of Independence of the United States of America, as shown in FIG. 2, chosen for its linguistic complexity and historical importance.

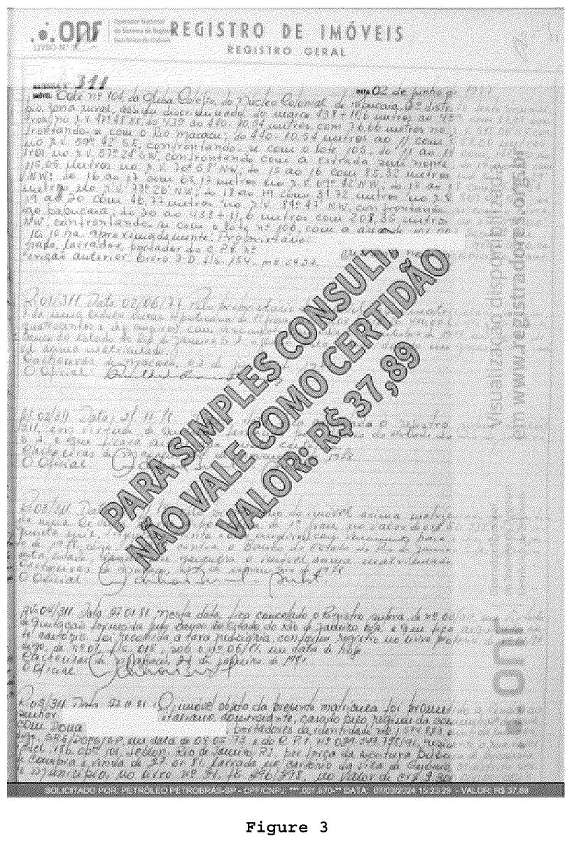

The second document, as shown in FIG. 3, is the Portuguese document, referring to a Property Registry—Registration No. 311, with an initial registration date of Jun. 2, 1977, belonging to the collection of the Electronic Property Registration System (SREI), managed by the National Operator of the Electronic Property Registration (ONR). This document represents a significant example of Brazilian notarial documentation, with its peculiarities of formatting and legal terminology. Data relating to the names of owners and other members, CPF, RG and other identifying elements have been hidden in accordance with the General Data Protection Law (LGPD), and replaced by XXXXX (for full names) or each digit replaced by an equivalent X.

Both documents provide challenging benchmarks for evaluating transcription quality across all three methods.

The comparison assesses character-level accuracy, word recognition rates, and preservation of semantic coherence. By analyzing performance on these complex documents, we aim to demonstrate the effectiveness of the method of the present invention in handling textual content in different languages and contexts, potentially advancing the field of document digitization and information extraction.

The specific objectives of the comparison are:
to quantify the literal accuracy of the present method in transcribing documents, comparing it with Azure Document Intelligence and GPT-4 Vision;
to evaluate the semantic preservation capability of the present method compared to the benchmark solutions.
to evaluate the technological effectiveness of the present method versus established tools in transcribing documents of several formats (PDF, images); and
to establish, through quantitative metrics, the performance differences between the present method and existing solutions in the accurate and semantically faithful transcription of documents.

The central hypothesis posits that the present method exhibits superior document transcription capabilities, evidenced by:
reduced error rate in literal word transcription;
enhanced preservation of the semantics of the original text; and
improved performance in several textual and semantic similarity metrics.

### Azure Document Intelligence

Azure Document Intelligence, formerly known as Form Recognizer, is an artificial intelligence service from Microsoft Azure that uses machine learning models to extract and analyze content from various documents. The Read model specializes in OCR and can process printed and handwritten text in over 164 languages. The Read model employs deep convolutional neural networks to detect and recognize characters, even under challenging conditions such as variable lighting or image distortions. The main features of Azure Document Intelligence include:
ability to extract text, tables, and document structures from scanned documents and photographs;
support for multiple file formats, including PDF, JPEG, and PNG;
high-precision handwriting recognition;
easy integration with other Azure services and RESTful APIs.

### GPT-4 Vision

GPT-4 Vision is an advanced multimodal model developed by OpenAI, capable of processing and analyzing both text and images. This model represents a significant advancement in AI, combining the powerful language comprehension capabilities of GPT-4 with computer vision technology. Key features of GPT-4 Vision include:
ability to interpret and describe complex visual scenes;
text comprehension in images, including handwritten content;
ability to process several image formats and PDFs;
contextual understanding of visual elements and their relationships.

GPT-4 Vision uses a Transformers-based architecture, allowing it to attend to the different parts of an image and correlate them with textual information. This enables the model to perform tasks such as answering visual questions, captioning images, and transcribing documents.

For OCR tasks, GPT-4 Vision leverages its visual processing capabilities to identify text regions within an image or PDF and then applies its language understanding to transcribe and interpret the content. Potentially, this approach offers advantages in handling complex layouts, varied fonts, and contextual text interpretation.

### Method of the Present Invention

The present method combines image processing, text segmentation, and character recognition techniques with large-scale language models.

### Validation Metrics

The transcription methods were evaluated against a standard reference (ground truth) using a diverse set of metrics. These metrics range from word error rate to vector space representation distances and textual similarity measures. Both the reference transcription and the outputs of each method are provided in the item named Appendix below.

### Metrics

### Word Error Rate (WER)

The Word Error Rate (WER) is a fundamental metric in the evaluation of OCR and speech recognition systems. WER quantifies the edit distance between a generated word sequence (hypothesis) and the reference sequence, normalized by the number of words in the reference, given by the equation below:

$$WER = ( S + D + I ) / N ,$$

where:
S=number of substitutions;
D=number of deletions;
I=number of insertions; and
N=number of words in the reference.

Lower WER values indicate better performance, with 0 being perfect and 1(100 %) indicating a complete error.

### Metrics Based on Embeddings

Text embeddings for the following metrics were generated using the OpenAI text-embedding-ada-002 (version 2) template:
Normalized Manhattan Distance: Sum of the absolute differences between embedding elements, normalized by the sum of the absolute values of the reference embedding. The smaller the distance, the greater the similarity. The best possible value is 0;
Euclidean Distance: Square root of the sum of the squared differences between embedding elements. The smaller the distance, the greater the similarity. The best possible value is 0;
Minkowski Distance: Generalization of Manhattan (p=1) and Euclidean (p=2) distances. The smaller the distance, the greater the similarity. The best possible value is 0;
Chebyshev Distance: Maximum absolute difference between corresponding embedding elements. The smaller the distance, the greater the similarity. The best possible value is 0;
Bray-Curtis Distance: Sum of the absolute differences divided by the sum of the absolute values. The smaller the distance, the greater the similarity. The best possible value is 0;
Cosine Similarity: Cosine of the angle between embedding vectors, ranging from −1 (opposite) to 1 (identical). In this case, the higher the value, the greater the similarity. The best possible value is 1;
Spearman Correlation: Monotonic correlation between the rankings of embedding elements. The closer to 1, the greater the positive correlation and therefore the greater the similarity. The best possible value is 1;
Kendall's Tau: Measures the ordinal relationship between pairs of embedding elements. The closer to 1, the greater the agreement and therefore the greater the similarity. The best possible value is 1.

This diverse set of metrics provides a comprehensive assessment of the performance of each transcription method, capturing several aspects of textual similarity and semantic preservation.

### Results

### Document in English—Declaration of Independence of the United States of America

### Word Error Rate (WER)

The Word Error Rate (WER) is a crucial metric for evaluating transcription accuracy, measuring the editing distance between the generated text and the reference. Analysis of the results revealed the following results, elucidated below.

The method of the present invention: Shows the best performance with a WER of 0.12, indicating that approximately 12% of the words would need correction to exactly match the reference text.

Azure Document Intelligence: Occupies second place with a WER of 0.28. About 28% of the words in its transcription require some form of editing to achieve a perfect match.

GPT-4 Vision: Registers a WER of 0.38, indicating that approximately 38% of the words need corrections. It is important to note that GPT-4 Vision failed to transcribe the entire text due to output token limitations, which significantly impacted its performance in this task.

### Distance Metrics

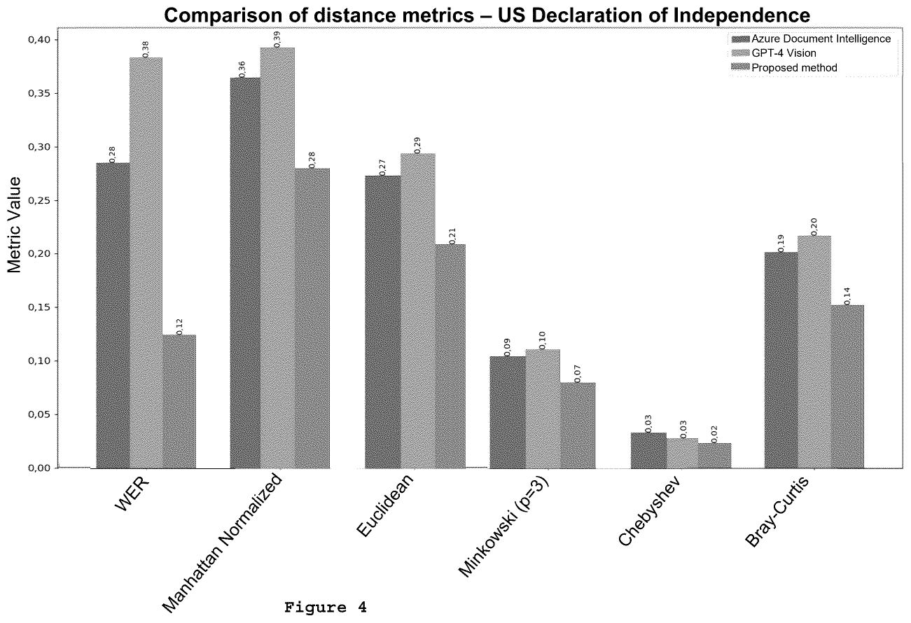

FIG. 4 shows a comprehensive comparison of the different distance metrics implemented to assess the similarity between the generated transcriptions and the reference text. Analyzing the results shown in FIG. 4, consistent patterns are observed, which are indicated below.

The method of the present invention: Consistently shows the shortest distances in all evaluated metrics, indicating the greatest similarity to the reference text.

Azure Document Intelligence: Occupies an intermediate position in terms of performance, with distance values higher than the present method, but lower than GPT-4 Vision.

GPT-4 Vision: Shows the highest distances in all metrics. These high values reflect incomplete transcription due to token limitations, resulting in a greater disparity between the transcript and the reference text.

### Similarity Metrics

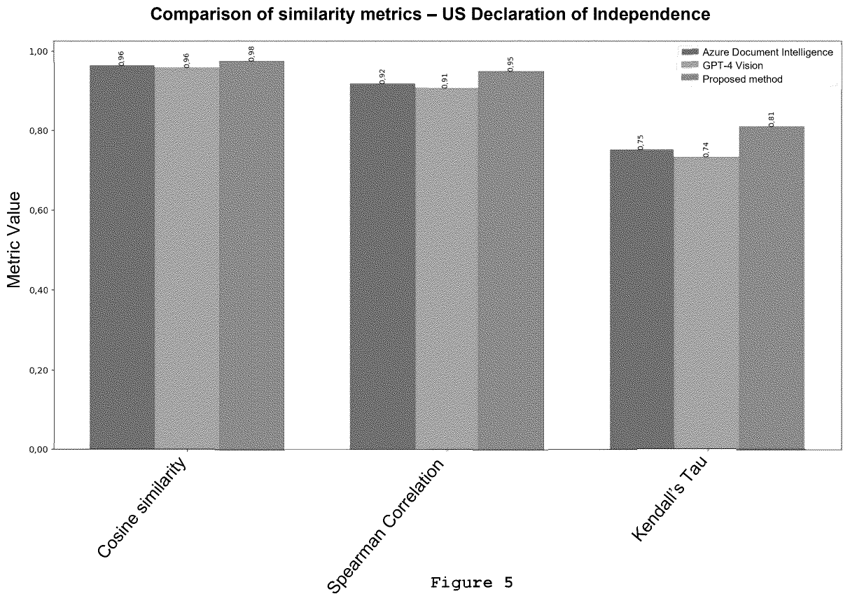

FIG. 5 shows a complementary analysis, focusing on similarity metrics that capture different aspects of the relationship between the transcripts and the reference text of the English document. Analyzing the results shown in FIG. 5, the following patterns are observed, highlighted below.

The method of the present invention: Shows the highest values in all similarity metrics evaluated, indicating strong structural and semantic correspondence with the reference text.

Azure Document Intelligence: Demonstrates robust performance, with similarity values close to, although slightly lower than, those of the present method.

GPT-4 Vision: Shows the lowest similarity values across all metrics. These low similarity values are largely attributable to incomplete transcription due to output token limitations, significantly impacting its performance in capturing the complete content and structure of the original text.

The superior performance of the present method in these metrics highlights its ability to preserve not only the literal content but also the structure and semantic relationships present in the original text. The good performance of Azure Document Intelligence suggests its effectiveness in capturing important aspects of the text, although to a lesser degree than the present method. The performance of GPT-4 Vision was significantly hampered by its inability to process the entire document due to token limitations, highlighting a key limitation of this approach for long document transcription tasks.

### Document in Portuguese—Property Registry—Registration No. 311

### Word Error Rate (WER)

The method of the present invention: Shows the best performance, presenting a WER of 0.50.

Azure Document Intelligence: Shows the worst performance, with a WER of 0.60.

GPT-4 Vision: Registers a WER of 0.57, showing performance close to Document Intelligence, although slightly superior.

### Distance Metrics

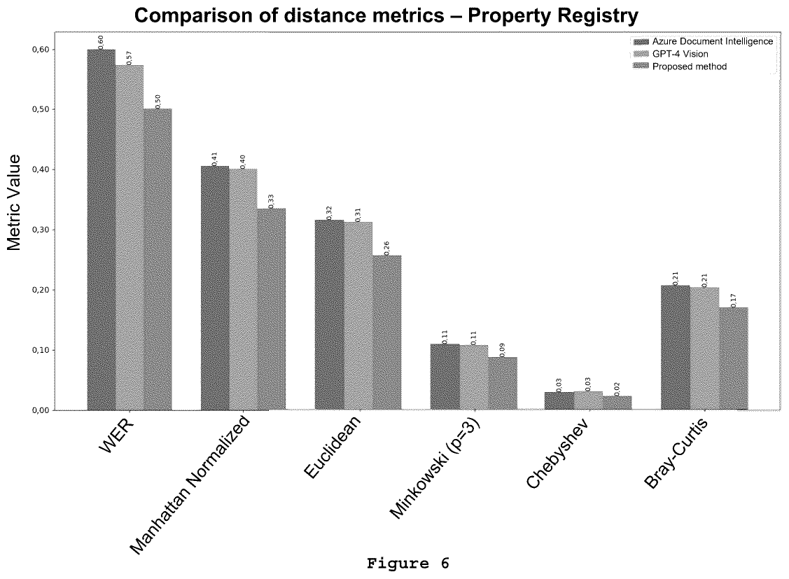

FIG. 6 shows a comprehensive comparison of the different distance metrics implemented to assess the similarity between the generated transcripts and the reference text of the document in Portuguese. Analyzing the results shown in FIG. 6, consistent patterns are also observed, as highlighted below.

The method of the present invention: Consistently shows the lowest distances in all metrics evaluated, indicating the greatest similarity with the reference text.

Azure Document Intelligence and GPT-4 Vision: Show very similar performances, both inferior to the proposed method, since the distances are greater in all metrics analyzed.

### Similarity Metrics

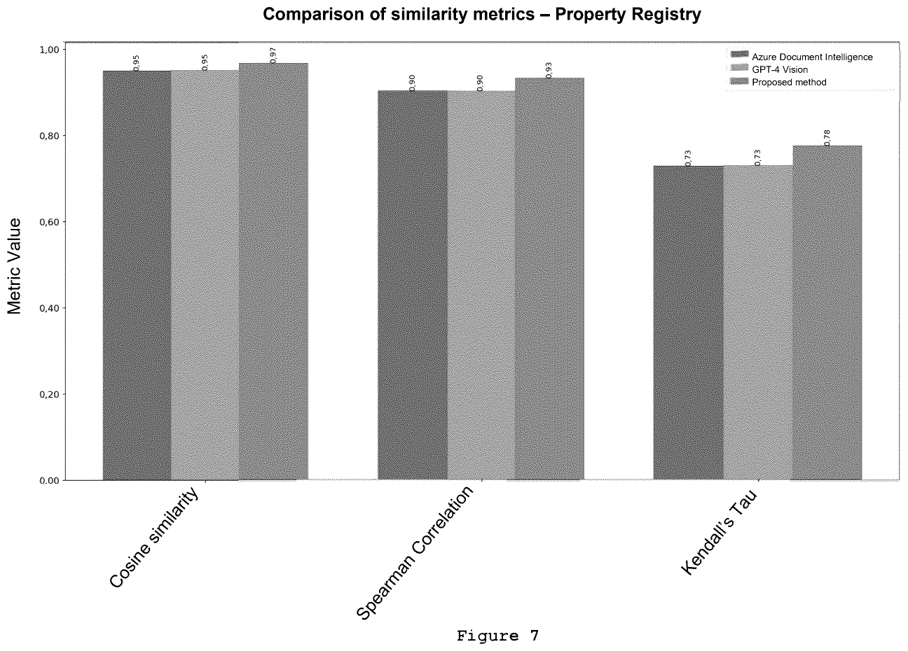

FIG. 7 shows a complementary analysis, focusing on similarity metrics that capture different aspects of the relationship between the transcripts and the reference text of the Portuguese document.

The method of the present invention: Shows the highest values in all similarity metrics evaluated, indicating greater structural and semantic correspondence with the reference text.

Azure Document Intelligence and GPT-4 Vision: Similarly to the distance metrics, the performance of both models is very similar, being consistently inferior to that of the proposed method.

The superior performance of the present method in the metrics analyzed for the Portuguese document highlights its ability to preserve not only the literal content, but also the structure and semantic relationships present in the original text. This is particularly noteworthy considering that the document contains specific legal terminology and formatting characteristic of Brazilian notarial records. Both Azure Document Intelligence and GPT-4 Vision demonstrated inferior performance, with WER above 0.57, and showed very similar results across all evaluated metrics. This consistent pattern of inferior performance can be attributed to the specific complexity of the Portuguese document, including its particular formatting and technical-legal terminology, aspects in which the method of the present invention demonstrated greater robustness. It is interesting to note that, even without the token limitations observed in the English document, GPT-4 Vision failed to significantly overcome Azure Document Intelligence and consequently did not overcome the proposed method.

Thus, the comparisons performed, using a diverse range of metrics including Word Error Rate (WER), distance measures and similarity indices, demonstrate the superior capability of the present method in manuscript transcription tasks.

The present method exhibited exceptional and consistent performance across all evaluated metrics, as elucidated below.

Literal Accuracy: The present method achieved the lowest WER, indicating high fidelity in the word-for-word transcription of the original text.

Semantic Similarity: In all distance metrics, the present method consistently showed the lowest values, evidencing strong semantic correspondence between its transcriptions and the reference text.

Structural Correlation: In similarity metrics, including cosine similarity, Spearman correlation, and Kendall's Tau, the present method achieved the highest scores, demonstrating superior ability to preserve the structure and contextual relationships of the original text.

This consistently superior performance across multiple evaluation dimensions underscores the effectiveness of the present method in manuscript transcription. The method of the present invention not only accurately captures the literal content of the text but also robustly preserves the semantic and structural aspects of the original manuscript. In summary, the present method emerges from this study as an exceptionally effective and reliable tool for manuscript transcription.

Those skilled in the art will appreciate the knowledge presented here and may reproduce the invention in the presented modalities and in other variants, covered within the scope of the appended claims.

### APPENDIX

### Azure Document Intelligence Transcript of the English Document—Declaration of Independence of the United States of America

IN CONGRESS, Jul. 4, 1776.

Che unanimous Declaration of the thirteen united States of America,

best in the Course of human events, it becomes necessary for one people to dissolve the political bands which have connected them with another, and to~assume among the flowers of the earth, He separate and equal ftation to which the Laws of. Nature and of Nature's God on title them, a decent respect to the opinions of mankind requires that they Should declare the causes which impul them to tie fiparatien. “We hold these truths to be self evident, that all men are created equal, that they are endowed by their Creator with certain unalienable Rights, that among these are Life, Liberty and the pursuit of Happiness That to secure these lights, Governments are instituted among Men, deriving their just flowers from the consent of the governed, That whenever any Form of Government becomes destructive of these ends, it is the Right of the People to alter or to abolish it, and to institute new Government, laying its foundation on such principles and organizing its powers in such form, as to them shall seem most likely to effect their Safety and Happiness. Prudence, indeed, will dictate that Governments long established Should not be changed for light and transient causes; and accordingly all experience hath fhewn, that mankind are more disposed to puffer, while evils are Sufferable, than to right themselves by abolishing the forms to which they are accustomed. But when along train of abuses and usurpations, pursuing invariably the same Object wines a design to reduce frem under absolute Despotism; it is their right, it is their duty, to throw of such Government, and to provide nuo Guards for their future security.

Such has been the patient fuferance of these Colonies; and such is now the necessity which constrains them to alter their former Systems of Government. The history of the present King of Great Britain is a history of repeated injuries and ufufutions, all having in direct object the establishment of an absolute Tyranny over these States. To prove this, let Facts be Submitted to a cand world. He has refused his afsent to Laus, the most wholesome and necessary for the public good. He has forbidden his Governors topafs Laws of immediate and feeling importance, unless suspended in their operation till his Afsent should be obtained; and when so Suspended, he has utterly neglected to allend to them He has refused to pays other Laws for the accommodation of large districts of people, unless those people would relinquish the right of Representation in the Legislature, a right ineflimable to them and formidable to tyrants only . . . He has called together legislative bodies at places unusual, uncomfortable, and distant from the depository of this public Records, for the sole purpose of fatiguing them into compliance with his measures. He has dissolved Representative Houses repeatedly, for opposing with manly firmnefs his invasions on the rights of the people. He has refused for along time, after such dissolutions, to cause others to be elected; whereby the Legislative flowers, incapable of Annihilation, have returned to the People at large for their exercise; the State remaining in the mean time exposed to all the dangers of invasion from without, and convulsions within? He has endeavoured to prevent the population of these States; for that purpose obstruct. Ting the Saus for naturalization of Jorigners; refusing topafs cthurs to encourage their migrations hither, and raising the conditions of new appropriations of Sands. He has obstructed the Administration of Justice, by refusing his afsent to Laws for establishing Judiciary flowers. He has made Judges dependent on his Walk alone, for the tenure of their offices, and the amount and payment of their salaries. He has erected a multitude of New Offices, and sont hither farms of Officers to kanals our people, and eat out this Substance He has kept among us, in times of peace, Standing Armies without the Consent of our legislatures. He has affected to under the Military independent of and superior to the Civil power? He has combined with others tojubject us to a jurisdiction foreign to our constitution, and unacknowledged by our laws; giving his sent to their Acts of pretended Legislation: For quartering large bodies of armed troops among us: For protecting them, by a mock Trial, from punishment for any Murders which they should commit on the Inhabitants of these States: ~For calling of our Trade with all parts of the world: For imposing Faces on us with out our Consent? For depriving us in many cases, of the benefits of Trial by Jury: For transporting us beyond Seas to be tried for pretended offences: For abolishing the file System of English Laws in a neighbouring Province, establishing therein an Arbitrary government, and enlarging it's Bourdais so as to render it at once an example and fit influment for introducing the same absolute tule into these Colonies: For taking away our Charters, abolishing our most valuable Laws, and altering fundamentally the Forms of our Governments: For suspending our own Legislatures, and declaring themselves invested with power to legislate for us in all cases whatsoever. ~He has

abdicated Government here by declaring us out of his Protection and waging War against us. He has plundered our seas, ravaged our boasts, bunt our towns, and destroyed the Lives four people. He is at this time transporting large Armies of foreign Mercenaries to complete the works of death, desolation and tyranny, already begun with circumstances of Cruelty & perfidy fearcely paralleled in the most barbarous ages, and totally unworthy the Head of a civilized nation. He has constrained our fellow Citizens taken Captive on the high Seas to bear arms against their bounty, to become the executiones of their friends and Buthun, or to fall themselves by their Hands. He has excited domestic infursections amongst us, and has endeavoured to bring on the inhabitants of our frontiers, the merciles Indian Savages, whose known rule of warfare, is an undistinguished destruction of all ages, fees and conditions. In wery frage of these Oppressions le have Petitioned for Redes in the most humble terms. Our repeated Petitions have been answered by repeated injury. A Rince, whose character is thus marked by every act which may define a Tyrant, is unfit to be the rules of a free people. Not have We been wanting in attentions to our British brethren. We have warned them from time to time of attempts by their legislature to extend an unwarrant. “able jurisdiction over us. We have reminded them of the circumstances of our migration and Settlement here. We have appealed to their native justice and magnanimity, and we have conjured them by the ties of our common kindred to disavow these ufurpations, which, would inevitably interrupt our connections and correspondence “They to have been deaf to the voice of justice and of, consanguinity. We must, therefore, acquiesce in the necessity, which denounces our Separation, and hold them, as we hold the rest of mankind, Enemies in War, in Peace Friends. We, therefore, the Representatives of the united States of America, in General Congress, Assembled, appealing to the Supreme Judge of the world for the rectitude of our intentions, do, in the Name, and by authority of the good People of these Colonies, Solemnly publish and declare, That these United Colonies are, and of Right ought to be Free and Independent States; that they are absolved from all allegiance to the British brown, and that all political connection between them and the State of Great Britain, is and ought to be totally dissolved; and that as Free and Independent States, they have full Power to levy War, conclude Peace, contract alliances, establish Commerce, and to do all other acts and Things which Independent States may of right do. And for the fifthort of this Declaration, with affirm reliance on the protection of divine Providence, we mutually pledge to each other our Lives, our Fortunes and our faired Honor
John Hancock Mobmorris
Josiah Bartlett n° Whipple
gym Hooper Joseph Heures,
Benjaminhush
Button Gewinnst Lymanistalles Geo Walton.
Chil Livingstou Sam Adams
Bong. Franklin
Saan Lewy John Adams
John Denn
Samuch Chaves
Com Paro
Lewis Morris Rob Frear Paint Elbridge Gerry
Tho: Stone John Norton
Edward Rutledge/.
GEO. Taylor James Wilson Auch Nochton
Step Hopkins
T. J. STONE S C. WASHY
William Ellery 6
George Wythe
Thomas Lynch Jun?
Ins Wichenpourle
Richard Henry Lee
Roger Sherman Sam “Huntington
Tra Hopkinson
Arthur Middleton
Th Jefferson
Casar Pormuy
John Hart M Y Williams
Bony Harrisone The Nelson fi
Tho M. Jak“
Abra Clark Oliver Wohnt Matthew Thornton
France's Lightfoot Lee
Garler Braxton

### GPT-4 Vision Transcript of the Document in English—Declaration of Independence of the United States of America

IN CONGRESS, Jul. 4, 1776.

The unanimous Declaration of the thirteen United States of America,

When in the Course of human events, it becomes necessary for one people to dissolve the political bands which have connected them with another, and to assume among the powers of the earth, the separate and equal station to which the Laws of Nature and of Nature's God entitle them, a decent respect to the opinions of mankind requires that they should declare the causes which impel them to the separation. “We hold these truths to be self-evident, that all men are created equal, that they are endowed by their Creator with certain unalienable Rights, that among these are Life, Liberty and the pursuit of Happiness. That to secure these rights, Governments are instituted among Men, deriving their just powers from the consent of the governed. That whenever any Form of Government becomes destructive of these ends, it is the Right of the People to alter or to abolish it, and to institute new Government, laying its foundation on such principles and organizing its powers in such form, as to them shall seem most likely to effect their Safety and Happiness. Prudence, indeed, will dictate that Governments long established should not be changed for light and transient causes; and accordingly all experience has shown, that mankind are more disposed to suffer, while evils are sufferable, than to right themselves by abolishing the forms to which they are accustomed. But when a long train of abuses and usurpations, pursuing invariably the same Object evinces a design to reduce them under absolute Despotism; it is their right, it is their duty, to throw off such Government, and to provide new Guards for their future security. Such has been the patient suffering of these Colonies; and such is now the necessity which constrains them to alter their former Systems of Government. The history of the present King of Great Britain is a history of repeated injuries and usurpations, all having in direct object the establishment of an absolute Tyranny over these States. To prove this, let Facts be submitted to a candid world. He has refused his assent to Laws, the most wholesome and necessary for the public good. He has forbidden his Governors to pass Laws of immediate and pressing importance, unless suspended in their operation until his Assent should be obtained; and when so suspended, he has completely neglected to attend to them. He has refused to pass other Laws for the accommodation of large districts of people, unless those people would relinquish the right of Representation in the Legislature, a right inestimable to them and formidable to tyrants only. He has called together legislative bodies at places unusual, uncomfortable, and distant from the depository of this public Records, for the sole purpose of fatiguing them into compliance with his measures. He has dissolved Representative Houses repeatedly, for opposing with manly firmness his invasions on the rights of the people. He has refused for a long time, after such dissolutions, to cause others to be elected; whereby the Legislative powers, incapable of Annihilation, have returned to the People at large for their exercise; the State remaining in the meantime exposed to all the dangers of invasion from without, and convulsions within. He has endeavored to prevent the population of these States; for that purpose obstructing the Laws for naturalization of Foreigners; refusing to pass others to encourage their migrations hither, and raising the conditions of new appropriations of Lands. He has obstructed the Administration of Justice, by refusing his assent to Laws for establishing Judiciary powers. He has made Judges dependent on his Will alone, for the tenure of their offices, and the amount and payment of their salaries. He has erected a multitude of New Offices, and sent hither swarms of Officers to harass our people, and eat out their Substance. He has kept among us, in times of peace, Standing Armies without the Consent of our legislatures. He has affected to render the Military independent of and superior to the Civil power. He has combined with others to subject us to a foreign jurisdiction to our constitution, and unacknowledged by our laws; giving his assent to their Acts of intended Legislation: For quartering large bodies of armed troops among us: For protecting them, by a mock Trial, from punishment for any Murders which they should commit on the Inhabitants of these States: For cutting off our Trade with all parts of the world: For imposing Taxes on us without our Consent: For depriving us in many cases, of the benefits of Trial by Jury: For transporting us beyond Seas to be tried for intended offences: For abolishing the free System of English Laws in a neighboring Province, establishing therein an Arbitrary government, and enlarging its Boundaries so as to render it at once an example and fit instrument for introducing the same absolute rule into these Colonies: For taking away our Charters, abolishing our most valuable Laws, and fundamentally altering the Forms of our Governments: For suspending our own Legislatures, and declaring themselves invested with power to legislate for us in all cases whatsoever. He has abdicated Government here by declaring us out of his Protection and waging War against us. He has plundered our seas, ravaged our coasts, burned our towns, and destroyed the Lives of our people. He is at this time transporting large Armies of foreign Mercenaries to complete the works of death, desolation and tyranny, already begun with circumstances of Cruelty & perfidy scarcely paralleled in the most barbarous ages, and totally unworthy the Head of a civilized nation. He has constrained ou

### Transcription of the Method of the Present Invention of the Document in English—Declaration of Independence of the United States of America

IN CONGRESS, Jul. 4, 1776

The Unanimous Declaration of the Thirteen United States of America

When in the course of human events, it becomes necessary for one people to dissolve the political bands which have connected them with another, and to assume among the powers of the earth, the separate and equal station to which the Laws of Nature and of Nature's God entitle them, a decent respect to the opinions of mankind require that they should declare the causes which impel them to the separation.

We hold these truths to be self-evident, that all men are created equal, that they are endowed by their Creator with certain unalienable Rights, that among these are Life, Liberty and the pursuit of Happiness. That to secure these rights, Governments are instituted among Men, deriving their just powers from the consent of the governed. That whenever any Form of Government becomes destructive of these ends, it is the Right of the People to alter or to abolish it, and to institute new Government, laying its foundation on such principles and organizing its powers in such form, as to them shall seem most likely to effect their Safety and Happiness. Prudence, indeed, will dictate that Governments long established should not be changed for light and transient causes; and accordingly all experience has shown, that mankind are more disposed to suffer, while evils are sufferable, than to right themselves by abolishing the forms to which they are accustomed. But when a long train of abuses and usurpations, pursuing invariably the same Object evinces a design to reduce them under absolute Despotism, it is their right, it is their duty, to throw off such Government, and to provide new Guards for their future security. Such has been the patient suffering of these Colonies; and such is now the necessity which constrains them to alter their former Systems of Government. The history of the present King of Great Britain is a history of repeated injuries and usurpations, all having in direct object the establishment of an absolute Tyranny over these States. To prove this, let Facts be submitted to a candid world.

He has refused his assent to Laws, the most wholesome and necessary for the public good.

He has forbidden his Governors to pass Laws of immediate and pressing importance, unless suspended in their operation until his Assent should be obtained; and when so suspended, he has completely neglected to attend to them.

He has refused to pass other Laws for the accommodation of large districts of people, unless those people would relinquish the right of Representation in the Legislature, a right inestimable to them and formidable to tyrants only. He has called together legislative bodies at places unusual, uncomfortable, and distant from the depository of their public records, for the sole purpose of fatiguing them into compliance with his measures.

He has dissolved Representative Houses repeatedly, for opposing with manly firmness his invasions on the rights of the people.

He has refused for a long time, after such dissolutions, to cause others to be elected; whereby the Legislative powers, incapable of Annihilation, have returned to the People at large for their exercise; the State remaining in the meantime exposed to all the dangers of invasion from without, and convulsions within.

He has endeavored to prevent the population of these States; for that purpose obstructing the Laws for naturalization of Foreigners; refusing to pass others to encourage their migrations hither, and raising the conditions of new appropriations of Lands.

He has obstructed the Administration of Justice, by refusing his assent to Laws for establishing Judiciary powers.

He has made Judges dependent on his Will alone, for the tenure of their offices, and the amount and payment of their salaries.

He has erected a multitude of New Offices, and sent hither swarms of Officers to harass our people, and eat out their substance.

He has kept among us, in times of peace, Standing Armies without the Consent of our legislatures.

He has affected to render the Military independent of and superior to the Civil power.

He has combined with others to subject us to a foreign jurisdiction to our constitution, and unacknowledged by our laws; giving his Assent to their Acts of intended Legislation:

For quartering large bodies of armed troops among us:

For protecting them, by a mock Trial, from punishment for any Murders which they should commit on the Inhabitants of these States:

For cutting off our Trade with all parts of the world:

For imposing Taxes on us without our Consent:

For depriving us in many cases, of the benefits of Trial by Jury:

For transporting us beyond Seas to be tried for intended offenses:

For abolishing the free System of English Laws in a neighboring Province, establishing therein an Arbitrary government, and enlarging its Boundaries so as to render it at once an example and fit instrument for introducing the same absolute rule into these Colonies:

For taking away our Charters, abolishing our most valuable Laws, and fundamentally altering the Forms of our Governments:

For suspending our own Legislatures, and declaring themselves invested with power to legislate for us in all cases whatsoever.

He has abdicated Government here by declaring us out of his Protection and waging War against us.

He has plundered our seas, ravaged our coasts, burned our towns, and destroyed the lives of our people.

He is at this time transporting large Armies of foreign Mercenaries to complete the works of death, desolation and tyranny, already begun with circumstances of Cruelty & perfidy scarcely paralleled in the most barbarous ages, and totally unworthy the Head of a civilized nation.

He has constrained our fellow Citizens taken Captive on the high Seas to bear arms against their country, to become the executiones of their friends and Buthun, or to fall themselves by their Hands.

He has excited domestic insurrections amongst us, and has endeavored to bring upon the inhabitants of our frontiers, the merciless Indian Savages, whose known rule of warfare is an undistinguished destruction of all ages, sexes, and conditions.

In every stage of these Oppressions, we have Petitioned for Redress in the most humble terms. Our repeated petitions have been answered by repeated injuries. A Prince, whose character is thus marked by every act which may define a Tyrant, is unfit to be the ruler of a free people.

Nor have We been wanting in attentions to our British brethren. We have warned them from time to time of attempts by their legislature to extend an unwarrantable jurisdiction over us. We have reminded them of the circumstances of our migration and settlement here. We have appealed to their native justice and magnanimity, and we have conjured them by the ties of our common kindred to disavow these usurpations, which would inevitably interrupt our connections and correspondence. They too have been deaf to the voice of justice and of consanguinity. We must, therefore, acquiesce in the necessity, which denounces our Separation, and hold them, as we hold the rest of mankind, Enemies in War, in Peace Friends.

We, therefore, the Representatives of the United States of America, in General Congress, Assembled, appealing to the Supreme Judge of the world for the rectitude of our intentions, do, in the Name, and by authority of the good People of these Colonies, solemnly publish and declare, That these United Colonies are, and of Right ought to be Free and Independent States; that they are absolved from all allegiance to the British Crown, and that all political connection between them and the State of Great Britain, is and ought to be totally dissolved; and that as Free and Independent States, they have full Power to levy War, conclude Peace, contract alliances, establish Commerce, and to do all other acts and Things which Independent States may of right do.

And for the support of this Declaration, with a firm reliance on the protection of divine Providence, we mutually pledge to each other our Lives, our Fortunes, and our sacred Honor
John Hancock
Mobmorris
Josiah Bartlett
Whipple No.
Gym Hooper
Joseph Heures
Benjaminhush
Button Gwinnett
Lymanistalles
Geo Walton
Chil Livingston
Sam Adams
Benj. Franklin
Saan Lewy
John Adams
John Denn
Samuch Chaves
With Paro
Lewis Morris
Rob Frear Paint
Elbridge Gerry
Tho: Stone
John Norton
Edward Rutledge
GEO. Taylor
James Wilson
Auch Nochton
StepHopkins
T. J. STONE
S C. WASHY
William Ellery
George Wythe
Thomas Lynch Jun
Ins Wichenpourle
Richard Henry Lee
Roger Sherman
Sam Huntington
Tra Hopkinson
Arthur Middleton
Th Jefferson
Casar Pormuy
John Hart
M Y Williams
Bony Harrisone
The Nelson
Tho M. Jak
Abra Clark
Oliver Wohnt
Matthew Thornton
Francis Lightfoot Lee
Garler Braxton

### Transcription From Azure Document Intelligence of the Document in Portuguese—Property Registry—Registration No. 311

MATRICULA N° 311

DATA 02 de junho de 1977. IMÓVEL: Dote n° 104, da Gleba Colégio, do núcleo Colonial de Papucaia, 2° distrito deste municí. bio, zona rural, assidu discriminado: do marco 43811,6 metros ao 439, com 87/13 me tros no L. V. 47° 48′NE, do 439 ao 440. 10.54 metros. com 76.66 metros no r. V. 51° 06″ NE. con. frontandose com o Rio macacu; do 440 10,54 metros ao 11 com 588,00 metros no r.v. 59° 42 SE, confrontandose com o lote 105; do 11 ao 14 com. 141.00 me tros no r.v. 57° 24 SW, confrontando com a Estrada sedí nome, do 14/90 75 com 115,05 metros no r.V. 70° 5 P′ NIN; do 15 ao 16 com 85,32 metros no rx 71° 29 NW; do 16 ao 17 com 65,17 metros una r.V. 69° 42′ NW; do 17 ao 18 com 56, 54 metros ulo r.V. 73 ° 26 NW; do 18 ao 19 com 31.72 metros no r.V. 80° 0}, Nn do 19 ao 20 com 46.77 metros no r.V. 84° 47 NW. confrontando. Se como corre. go sapucaia ; do 20 ao 43811,6 metros com 208,35 metros no rx39900 NW confrontandose com o lote n° 106, com a área 10, 10 ha. aproximadamente: Proprietário: XXXXX, lavrador, portador do c. P. F. n° XXX.XXX.XXX, Pre crição anterior: biuro 3.D. Ils. 154, n° 2437.

10% 003. 300 2° du
Oliveira, brasileño, ca.

### ne PARA SIMPLES CONSULTA NÃO VALE COMO CERTIDÃO

nicipio. Trans

K:01/311. Data: Feb. 6, 1977. Telo proprietário tida uma cédula Rural Apoticaria de 1° frau quatrocentos e dez auxeuros), com vencimento Banco do Estado do Rio de Janeiro S. A. a ja Vil acima matriculado. Cachoeiras de macaca, 02 de

matriculada
410,00 (vinte
tubro de 1978, cut e un garant
Visualização disportil
em www.registradore
do
1

### Official: Quelles han

### AV. 02/3/1. Data, 27. 11. 18.

1
311, em virtude de que e

### VALOR: R$ 37,89

do o registro supor co do Estado de Rio de janeiro

S. A. e que ficará ai Cachoeiras de mazaci Vecce

19 fz

### O Oficial

### C

1

### K: 03/311. Dat

da una Cídas quenta vil, frizer foto de 1918. diego 6 desta cidade, dando Cachoeiras de

### O Oficial

9 nio do imóvel acima matriculado to
de 1° frace, no valor de cr$ 50.338€
nta. a o cruzeiros), com vencimento para o via contra o Banco do Estado do Rio de Janeiro S/A garantia o imóvel acima matriculado

Operadoo Nacional do Sistema de Registro: unselected:

Eletrônico de Imoveis: unselected:

ce
1778
lia ilst.

AV: 04/311. Data: 27.01.81. nesta data, fica cancelado o Registro supra de n° 03/311, que Virtude de quitação fornecida puo Banco do Estado do Rio de Janeiro B/A. e que fica arquivada vos te cartório.

foi recolhida a taxa judiciária, conforme registro no livro protorio de n° 06/11. digo, de n° 01, 1/s. 014, 206 o n° 06/81, em data de hoje. Cachoeiras de propagaci, 27 de janeiro de 1981. E oficial

3/3
on

KOS/311, Data: 27.11.81. O imóvel objeto da presente matrícula foi prometido à Venda ao sentior Xxxxx Xxxxxx, italiano, Comerciante, casado peço regiune da comunhão de caus com Doua XXXXX, portadores da identidade no X.XXX.XXX emitida pelo BRA, Ligo, SRE/DOPS/SP em data de 04.05.73, do @ P. F. n° XXX.XXX.XXX/XX, residente a rua tadel adel, 186. abt° 101, Leblon Rio de Janeiro R J, por força da escritura pública de promessa de Compra e venda de 27.01.81, lavrada no cartório da Vila de Subaio 3° distrito des. E município, no livro n° 21, Hs. 996/298, no Valor de cr$ 2.300.000,00 (dois SOLICITADO POR: PETRÓLEO PETROBRÁSSP CPF/CNPJ:. 001.670 DATA: Jul. 3, 2024 15:23:29 VALOR: R$ 37,89: selected:

### Transcription of the GPT-4 Vision Document in Portuguese—Property Registry—Registration No. 311

. . . ONF LIVRO N.° 2

11

Operador Nacional do Sistema de Registro de Imóveis

Eletrônico de Impóveis REGISTRO GERAL

MATRÍCULA N° 311

DATA 02 de junho de 1977. IMÓVEL: Dote n° 104, da Gleba Colégio, do núcleo Colonial de Papucaia, 2° distrito deste município, zona rural, assim discriminado: do marco 438+11,6 metros ao 439, com 87/13 metros no L. V. 47° 48′ NE, do 439 ao 440, 10,54 metros, com 76,66 metros no r. V. 51° 06′ NE, confrontando-se com o Rio Macacu; do 440-10,54 metros ao 11 com 588,00 metros no r.v. 59° 42′ SE, confrontando-se com o lote 105; do 11 ao 14 com 141,00 metros no r.v. 57° 24′ SW, confrontando com a Estrada; do 14/90 75 com 115,05 metros no r.V. 70° 5′ P′ NIN; do 15 ao 16 com 85,32 metros no r.v. 71° 29′ NW; do 16 ao 17 com 65,17 metros no r.V. 69° 42′ NW; do 17 ao 18 com 56,54 metros no r.V. 73° 26′ NW; do 18 ao 19 com 31,72 metros no r.V. 80° 0′, N; do 19 ao 20 com 46,77 metros no r.V. 84° 47′ NW, confrontando-se como corre com Sapucaia; do 20 ao 438+11,6 metros com 208,35 metros no r.v. 39° 00′ NW, confrontando-se com o lote n° 106, com a área de 10,10 ha, aproximadamente: Proprietário: XXXXX, lavrador, portador do C.P.F. n° XXX.XXX.XXX, Prescrição anterior: livro 3.D. Ils. 154, n° 2437.

10% 003. 300 2° du

Oliveira, brasileiro, ca.

PARA SIMPLES CONSULTA NÃO VALE COMO CERTIDÃO

município. Trans—

K:01/311. Data: Feb. 6, 1977. Título proprietário: cédula Rural Apoticaria de 1° fração, quatrocentos e dez mil cruzeiros, com vencimento no Banco do Estado do Rio de Janeiro S. A. já matriculado. Cachoeiras de Macacu, 02 de outubro de 1978, com garantia.

Visualização disponível em www.registradore

do
1

### Oficial: Quelles han

### AV. 02/3/1. Data: 27.11.18.

1
311, em virtude de que

### VALOR: R$ 37,89

do registro supor do Estado do Rio de Janeiro S. A. e que ficará arquivado em Cachoeiras de Macacu.

### O Oficial

### C

1
K: 03/311. Data: 27.11.81. O imóvel objeto da presente matrícula foi prometido à venda ao senhor XXXXX, italiano, comerciante, casado sob o regime da comunhão de bens com Dona XXXXX, portadores da identidade n° X.XXX.XXX emitida pelo BRA, Ligo, SRE/DOPS/SP em data de 04.05.73, do C.P.F. n° XXX.XXX.XXX/XX, residente à Rua Tadeu Adel, 186, apt° 101, Leblon—Rio de Janeiro—R J, por força da escritura pública de promessa de compra e venda de 27.01.81, lavrada no cartório da Vila de Subaio, 3° distrito deste município, no livro n° 21, fls. 996/298, no valor de cr$ 2.300.000,00 (dois milhões e trezentos mil cruzeiros).

SOLICITADO POR: PETRÓLEO PETROBRÁS-SP—CPF/CNPJ: * * * . 001.670-** DATA: Jul. 3, 2024 15:23:29—VALOR: R$ 37,89.

### Transcription From the Method of the Present Invention of the Document in Portuguese—Property Registry—Registration No. 311

OnF Livro N.° 2

Operador Nacional do Sistema de Registro de Imóveis Eletrônico de Imóveis

### REGISTRO GERAL

### MATRÍCULA N° 311

DATA: 02 de junho de 1977.

IMÓVEL: Lote n° 104, da Gleba Colégio, do núcleo Colonial de Papucaia, 2° distrito deste município, zona rural, assim discriminado: do marco 43811,6 metros ao 439, com 87/13 metros no L. V. 47° 48′ NE, do 439 ao 440, 10,54 metros, com 76,66 metros no r.V. 51° 06′ NE, confrontando-se com o Rio Macacu; do 44010,54 metros ao 11 com 588,00 metros no r.V. 59° 42′ SE, confrontandose com o lote 105; do 11 ao 14 com 141,00 metros no r.V. 57° 24′ SW, confrontando com a Estrada sem nome; do 14 ao 15 com 115,05 metros no r.V. 70° 5′ N; do 15 ao 16 com 85,32 metros no r.V. 71° 29′ NW; do 16 ao 17 com 65,17 metros no r.V. 69° 42′ NW; do 17 ao 18 com 56,54 metros no r.V. 73° 26′ NW; do 18 ao 19 com 31,72 metros no r.V. 80° 0′ N; do 19 ao 20 com 46,77 metros no r.V. 84° 47′ NW, confrontandose com o córrego Sapucaia; do 20 ao 43811,6 metros com 208,35 metros no r.V. 39° 00′ NW, confrontandose com o lote n° 106, com a área de 10,10 ha aproximadamente.

Proprietário: XXXXX, lavrador, portador do CPF n° XXX.XXX.XXX.

Inscrição anterior
Livro 3.D. Fls. 154, n° 2437. 10% 003. 300 2° du Oliveira, brasileiro.

### PARA SIMPLES CONSULTA NÃO VALE COMO CERTIDÃO

### Transcrição: K:01/311. Data: Feb. 6, 1977.

### Cédula Rural

O proprietário tem uma Cédula Rural Hipotecária de 1° grau no valor de quatrocentos e dez cruzeiros, com vencimento no Banco do Estado do Rio de Janeiro S. A., a favor do proprietário acima matriculado. Cachoeiras de Macacu, 02 de outubro de 1978.

Visualização disponível em

www.registradoredo1official.com

### AV. 02/311. Data: 27/11/18.

Em virtude de quitação fornecida pelo Banco do Estado do Rio de Janeiro S. A., fica cancelado o Registro supra de n° 03/311, conforme registro no livro n° 06/11, fls. 014, n° 06/81, em data de hoje. Cachoeiras de Macacu, 27 de janeiro de 1981.

### Promessa de Venda

O imóvel objeto da presente matrícula foi prometido à venda ao senhor XXXXX, italiano, comerciante, casado pelo regime da comunhão de bens com Dona XXXXX, portadores da identidade n° X.XXX.XXX emitida pelo BRA, Ligo, SRE/DOPS/SP em data de Apr. 5, 1973, do CPF n° XXX.XXX.XXX/XX, residente à Rua Tadel Adel, 186, apt° 101, Leblon, Rio de Janeiro, R J, por força da escritura pública de promessa de compra e venda de 27/01/81, lavrada no cartório da Vila de Subaio, 3° distrito deste município, no livro n° 21, fls. 996/298, no valor de cr$ 2.300.000,00 (dois milhões e trezentos mil cruzeiros).

What is claimed is:

1. A computer-implemented method for text recognition, comprising the following steps:
receiving a scanned file, which includes receiving a scanned file on a processing server;
including at least one metadata for the scanned file, which includes file size, file format, and file receipt time;
creating a unique identifier for a workflow associated with the scanned file, in a workflow management module;
extracting text and structuring the scanned file by Optical Character Recognition (OCR);
refining and enhancing the text extracted by OCR, by the Large-Scale Language Model (LLM) module, which includes semantic analysis of the text for contextual understanding and correction of gaps or inaccuracies in the text;
reconstructing the text;
temporary storing the file in primary memory, by the temporary storage module;
user decides whether to interact with an interactive chat tool;
implementing an interactive chat interface, through the chat interface module, if the user decides to interact with the interactive chat tool;
processing user queries and generating contextualized responses by Large-Scale Language Model (LLM); and
outputting a response generated by the Large-Scale Language Model (LLM).

2. The method according to claim 1, wherein the step of receiving a scanned file also includes checking if the format of the scanned file corresponds to a supported format, and
wherein the supported format comprises any format among: PDF, JPEG, PNG, TIFF, DOC, DOCX, XLS or XLSX or any other format that includes a scanned file.

3. The method according to claim 1, wherein the step of extracting text and structuring the scanned file by Optical Character Recognition (OCR) includes the use of optical character recognition algorithms, including convolutional neural networks (CNNs), recurrent neural networks (RNNs) and Transformers; and
wherein extracting text and structuring the scanned file also includes processing a plurality of languages and font styles through the use of pre-trained models on a plurality of texts of different languages, styles and formats.

4. The method according to claim 1, wherein the step of refining and improving the text extracted by OCR also includes identification of inconsistencies and ambiguities in the extracted text based on explicit instructions given to the model; spelling and grammar correction based on the document context; reconstruction of lists and tables; adjusting connectives and transitions between paragraphs to improve text flow; harmonizing styles and tones throughout the document; and adjusting the level of formality and terminology based on the document type.

5. The method according to claim 1, wherein the step of reconstructing the text includes:
transforming refined text into Markdown format, preserving the structural hierarchy of the document (titles, subtitles, paragraphs);
converting textual elements to Markdown syntax, including: formatting ordered and unordered lists, bold and italic emphasis; creating internal and external links, when applicable; formatting quotations and code blocks, if present;
converting identified tables to Markdown table format;
aligning columns and format table headers;
applying consistent styles to improve readability; and
inserting line breaks and appropriate spacing.

6. The method according to claim 1, wherein the step of temporarily storing the file in primary memory includes associating the stored file with a user session.

7. The method according to claim 1, wherein the method further comprises:
displaying the file in the user interface, which includes converting Markdown to HTML format for display in the browser and applying CSS styles to improve readability and appearance.

8. The method according to claim 1, wherein the step of processing user queries and generating contextualized responses by Large-Scale Language Model (LLM) includes:
incorporating relevant conversation history;
including pertinent parts of the processed document;
structuring the question of the user in a format optimized for LLM processing;
including specific instructions based on the query type; and
generating a response considering the complete context of the interaction with the document.

9. A non-transitory computer-readable medium having computer executable instructions stored thereon, wherein the instructions, when executed by a computer, cause the computer to perform the method according to claim 1.
